(19) United States
(12) Patent Application Publication
(10) Pub. No.: US 2007/0263138 A1
(43) Pub. Date: Nov. 15, 2007

(54) CIS (Contact Image Sensor) device without any optical imaging elements

(75) Inventors: Chia-Chu Cheng, Hsin-Tien City (TW); Shr-Bin Wu, Hsin-Tien City (TW); Yu-Wei Lu, Hsin-Tien City (TW); Tun-Cheng Hsu, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORPORATION

(21) Appl. No.: 11/431,746

(22) Filed: May 11, 2006

(51) Int. Cl. G02F 1/1335

(52) U.S. Cl. 349/96

(57) ABSTRACT

A CIS (Contact Image Sensor) device that doesn't require any optical imaging elements includes a circuit board, a light-emitting module, and an image-sensing module. The light-emitting module is electrically connected with the circuit board. The image-sensing module is electrically connected with the circuit board and disposed beside the light-emitting module. Thereby, a light beam is projected from the light-emitting module to a document to form a bouncing light, and the image-sensing module is adjacent to the document to receive the bouncing light for sensing the image of the document. Hence, the present invention without the known GRIN not only reduces the manufacturing cost and the size of the CIS device, but also solves the known problems of assembly tolerance and large size.

### BACKGROUND OF THE INVENTION

1. Field of the Invention

The present invention relates to a CIS (Contact Image Sensor) device, and particularly relates to a CIS device that doesn't require any optical imaging elements such as GRIN (Gradient Reflective Index).

2. Description of the Related Art

Referring to FIGS. 1 and 2, a known CIS (Contact Image Sensor) device includes a package casing 10a, a circuit board 20a, a cover glass 30a, an image-sensing element 40a, a GRIN optical element 50a, and a light-emitting element 60a.

The cover glass 30a and the circuit board 20a are respectively installed in an upper side and a lower side of the package casing 10a to form an upper space 100a and a lower space 200a. The image-sensing element 40a is disposed on the circuit board 20a and in the lower space 200a of the package casing 10a. The GRIN optical element 50a is disposed between the upper space 100a and the lower space 200a. Moreover, the light-emitting element 60a is disposed in the upper space 100a and beside the GRIN optical element 50a. Whereby, a light beam L1 is projected from the light-emitting element 60a to a document D through the cover glass 30a to form a bouncing light L2, the bouncing light L2 is transmitted to the image-sensing element 40a through the GRIN optical element 50a for sensing the image of the document.

Hence the GRIN optical element 50a is a necessary element in the known CIS device. However, using the GRIN optical element 50a makes the known CIS device's overall size increase. Moreover, assembling the GRIN optical element 50a into the package casing 10a produces an assembly tolerance. In addition, the GRIN optical element 50a is very expensive, so that the known CIS device's manufacturing cost is increased.

### SUMMARY OF THE INVENTION

The present invention provides a CIS device that doesn't require any optical imaging elements such as GRIN (Gradient Reflective Index) between a document and an image-sensing module. Hence, in the present invention the CIS device's cost is reduced, and the present invention solves the known problems of assembly tolerance and large size.

A first aspect of the invention is a CIS (Contact Image Sensor) device without any optical imaging elements, comprising: a circuit board, a light-emitting module, and an image-sensing module. The light-emitting module is electrically connected with the circuit board. The image-sensing module is electrically connected with the circuit board and disposed beside the light-emitting module. Thereby, a light beam can be projected from the light-emitting module to a document to form a bouncing light, and the image-sensing module is adjacent to the document to receive the bouncing light for sensing the image of the document.

A second aspect of the invention is a CIS (Contact Image Sensor) device without any optical imaging elements, comprising: a circuit board, a light-guiding element, a light-emitting element, and an image-sensing module. The light-emitting element is electrically connected with the circuit board and disposed beside the light-guiding element. The image-sensing module is electrically connected with the circuit board and disposed beside the light-emitting element. Thereby, a light beam can be projected from the light-emitting element to a document through a light-guiding element to form a bouncing light, and the image-sensing module is adjacent to the document to receive the bouncing light for sensing the image of the document.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, exposed view of a CIS of a prior art;

FIG. 2 is a side, exposed view of a CIS of a prior art;

FIG. 3 is a perspective, assembled view of a CIS device without any optical imaging elements according to the first embodiment of the present invention;

FIG. 4 is a perspective, exposed view of a CIS device without any optical imaging elements according to the first embodiment of the present invention;

FIG. 5 is a perspective, assembled view of a CIS device without any optical imaging elements according to the second embodiment of the present invention; and

FIG. 6 is a perspective, exposed view of a CIS device without any optical imaging elements according to the second embodiment of the present invention.

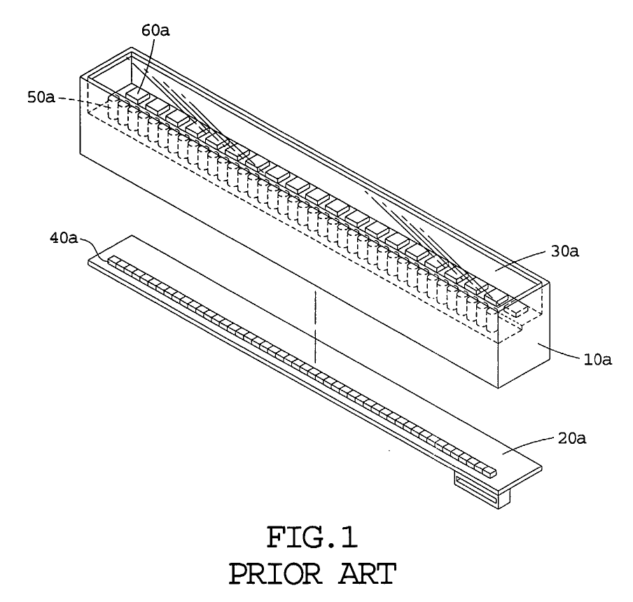

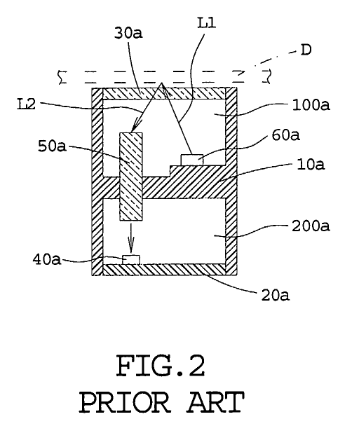

### DETAILED DESCRIPTION OF PREFERRED EMBODIMENTS

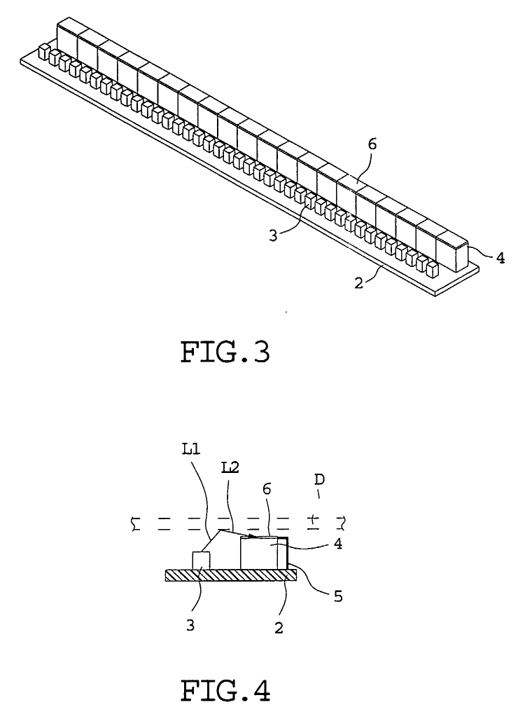

Referring to FIGS. 3 and 4, the present invention of the first embodiment provides a CIS (Contact Image Sensor) device without any optical imaging elements. The CIS device comprises a circuit board 2, a light-emitting module 3, and an image-sensing module 4.

The light-emitting module 3 is electrically connected with the circuit board 2, and the light-emitting module 3 can be a light-emitting element or it can be made of many light-emitting elements arranged in line. Moreover, according to a user's requirements, the light-emitting module 3 can be a fluorescent lamp, an EL (Electro-luminescent), an LED, or any other type of light-emitting device. However, the above-mentioned arrangement of the light-emitting module 3 should not be used to limit the present invention. For example, the light-emitting elements can be arranged in two or three rows, or in any other shape.

Furthermore, the image-sensing module 4 is electrically connected with the circuit board 2 via wires 5. The image-sensing module 4 is electrically connected with the circuit board 2 and disposed beside the light-emitting module 3. In addition, the image-sensing module 4 can be an image-sensing element or it can be made of many image-sensing elements arranged in line. According to a user's need, the image-sensing module 4 can be a 1D or 2D CIS, and the image-sensing module 4 can be a monochromatic CIS or a color CIS.

Moreover, the CIS device of the present invention further comprises a protective layer 6 formed on the image-sensing module 4 for protecting the image-sensing module 4. The protective layer 6 can be a coating/printing layer, an ordered optical fiber bundle, or a MCA (Micro Channel Array). In addition, the protective layer 6 has a thickness of between 0.1 to 10 mm, and the protective layer 6 can be made of transparent material. Hence, the image-sensing module 4 is exposed via the transparent protective layer 6 and is very close to a document D.

Thereby, a light beam L1 is projected from the light-emitting module 3 to a document D to form a bouncing light L2, and the image-sensing module 4 is adjacent to the document D to directly receive the bouncing light L2 without using a GRIN optical element 50a as in the prior art.

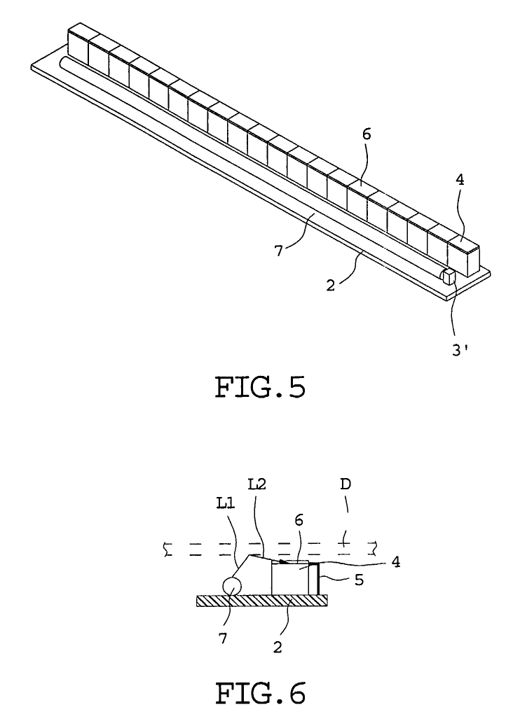

Referring to FIGS. 5 and 6, the present invention of the second embodiment provides a CIS (Contact Image Sensor) device without any optical imaging elements. The difference between the first embodiment and the second embodiment is that the CIS device of the second embodiment includes a light-guiding element 7, and a light-emitting element 3′ substituted for the light-emitting module 3. Moreover, the light-emitting element 3′ is electrically connected with the circuit board 2 and disposed beside the light-guiding element 7. The image-sensing module 4 is disposed beside the light-emitting element 3′.

Whereby, a light beam L1 is projected from the light-emitting element 3′ to a document D through a light-guiding element 7 to form a bouncing light L2, and the image-sensing module 4 is adjacent to the document D to directly receive the bouncing light L2 without using a GRIN optical element 50a as in the prior art.

In conclusion, the present invention does not use any optical imaging elements such as GRIN (Gradient Reflective Index) 50a between the document D and the image-sensing module 4. Hence, the present invention's cost is reduced, and the problems of the prior art, such as assembly tolerance and large size, are overcome.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A CIS (Contact Image Sensor) device without any optical imaging elements, comprising:
a circuit board;
a light-emitting module electrically connected with the circuit board; and
an image-sensing module electrically connected with the circuit board and disposed beside the light-emitting module;
wherein a light beam is projected from the light-emitting module to a document to form a bouncing light, and the image-sensing module is adjacent to the document to receive the bouncing light for sensing the image of the document.

2. The CIS device as claimed in claim 1, wherein the light-emitting module is a light-emitting element or is made of many light-emitting elements arranged in line.

3. The CIS device as claimed in claim 1, wherein the light-emitting module is a fluorescent lamp, an EL (Electro-luminescent), or an LED.

4. The CIS device as claimed in claim 1, wherein the image-sensing module is an image-sensing element or is made of many image-sensing elements arranged in line.

5. The CIS device as claimed in claim 1, wherein the image-sensing module is a 1D or 2D CIS.

6. The CIS device as claimed in claim 1, wherein the image-sensing module is a monochromatic CIS.

7. The CIS device as claimed in claim 1, wherein the image-sensing module is a color CIS.

8. The CIS device as claimed in claim 1, wherein the image-sensing module is electrically connected with the circuit board via wires.

9. The CIS device as claimed in claim 1, further comprising: a protective layer formed on the image-sensing module for protecting the image-sensing module.

10. The CIS device as claimed in claim 9, wherein the protective layer has a thickness of between 0.1 to 10 mm.

11. The CIS device as claimed in claim 9, wherein the protective layer is made of transparent material.

12. The CIS device as claimed in claim 9, wherein the protective layer is a coating layer, an ordered optical fiber bundle, or a MCA (Micro Channel Array).

13. A CIS (Contact Image Sensor) device without any optical imaging elements, comprising:
a circuit board;
a light-guiding element;
a light-emitting element electrically connected with the circuit board and disposed beside the light-guiding element; and
an image-sensing module electrically connected with the circuit board and disposed beside the light-emitting element;
wherein a light beam is projected from the light-emitting element to a document through a light-guiding element to form a bouncing light, and the image-sensing module is adjacent to the document to receive the bouncing light for sensing the image of the document.

14. The CIS device as claimed in claim 13, wherein the light-emitting element is an EL (Electro-luminescent) or an LED.

15. The CIS device as claimed in claim 13, wherein the image-sensing module is an image-sensing element or is made of many image-sensing elements arranged in line.

16. The CIS device as claimed in claim 13, wherein the image-sensing module is a 1D or 2D CIS.

17. The CIS device as claimed in claim 13, wherein the image-sensing module is a monochromatic CIS.

18. The CIS device as claimed in claim 13, wherein the image-sensing module is a color CIS.

19. The CIS device as claimed in claim 13, wherein the image-sensing module is electrically connected with the circuit board via wires.

20. The CIS device as claimed in claim 13, further comprising: a protective layer formed on the image-sensing module for protecting the image-sensing module.

21. The CIS device as claimed in claim 20, wherein the protective layer has a thickness of between 0.1 to 10 mm.

22. The CIS device as claimed in claim 20, wherein the protective layer is made of transparent material.

23. The CIS device as claimed in claim 20, wherein the protective layer is an ordered optical fiber bundle or a MCA (Micro Channel Array).
